(19) United States
(12) Patent Application Publication
(10) Pub. No.: US 2012/0195220 A1
(43) Pub. Date: Aug. 2, 2012

(54) Wireless Mesh Network and Method of Frequency Optimization

(75) Inventors: Tolga Kurt, Istanbul (TR); Firat Birlik, Istanbul (TR); Metin Ismail Taskin, Atasehir (TR)

(73) Assignee: Airties Kablosuz Iletisim Sanayi Ve Disticaret Anonim Sirketi, Istanbul (TR)

(21) Appl. No.: 13/389,414

(22) PCT Filed: Aug. 27, 2009
(86) PCT No.: PCT/IB2009/053746

§ 371 Date: Apr. 16, 2012

(30) Foreign Application Priority Data
Aug. 7, 2009 (TR) 2009/06140

(51) Int. Cl. H04W 24/00

(52) U.S. Cl. 370/252

(57) ABSTRACT

The present invention relates to a wireless mesh network and a method of frequency optimization comprising devices such as router over which the connection established with the other networks is routed, access points which act as a data transmission point in the network and client devices which use the network resources over access points; operate with the IEEE 802.11n standards compatibly and wherein the most appropriate channel is selected by monitoring the frequencies of the current and candidate channel on which the data transmission is carried out.

### FIELD OF THE INVENTION

The present invention relates to a wireless mesh network which operates according to the IEEE 802.11n standards and a method of real-time frequency optimization.

### BACKGROUND OF THE INVENTION

Wireless mesh networks usage areas of which are becoming wider in the present day are basically consisted of a router connected to the external networks (A) (for example internet), access points with which mutual data transmission is provided over the router and client devices connected to these points as wired or wirelessly. Quality of data transmission in the wireless mesh networks constitutes an important parameter for quality of service. Therefore particularly in wireless mesh networks (for example in networks near which many other wireless home networks operate) which are exposed to interference, there occurs a need to monitor and control the communication quality in the preferred channels throughout the network. For this purpose, it is required to monitor the transmission quality of different channels without subjecting the data transmission to failure and select the most appropriate channel by making frequency optimization for the afore-mentioned wireless network.

In frequency optimization, the commonly used approach is based on that the best possible channel is present independently of the data transmission in the network. For this purpose; the electronic devices (personal computer, laptop computer, digital satellite receiver, etc.), having wireless fidelity (Wi-Fi) feature, described as client devices within the scope of the network follow the alternative channels by their frequency synchronization module. With measurements carried out regarding the alternative channels, it is determined whether the channel is appropriate or not on the basis of criteria such as CCA (Clear Channel Assessment) which indicates number of access point present on the channel at that moment or occupancy ratio of the channel. But owing to the fact that, usually there is a single frequency synchronization module in Wi-Fi devices, one device can only follow and assess one channel at the same time in this solution method. In the event that measurements regarding another channel is carried out by the device, services (such as video, voice transmission) requiring continuity in the current channel are interrupted and the quality of data transmission in the wireless network decreases. This situation poses a problem particularly during real-time data transmission.

For the problems outlined above, developing frequency optimization solutions in accordance with the IEEE 802.11n standard in wireless mesh networks becomes important. Because with the IEEE 802.11n standard, multiple-input multiple-output (MIMO) communication realizes data transmission and frame aggregation in both 20 MHz and 40 MHz bandwidths. The IEEE 802.11n standard enables to enhance the data transfer rate in wireless networks by means of these features thereof.

The Japanese patent document JP2007158485, an application in the state of the art, discloses a transmission system wherein channel selection is realized automatically without subjecting the data flow in a wireless network to interruption. In this invention, a wireless local area network (LAN) device monitors peripheral frequencies and records interference information.

The United States patent document no. US2007149230A1, an application in the state of the art, discloses a method of dynamical frequency selecting in a wireless local area network. Alternative channels and transmission qualities of these channels are scanned and channel is switched by means of selecting one channel based on the quality priority by a main wireless network device. However, since particularly in transmission of high resolution video signals it is required not to fall below a certain data transmission rate during channel switching, particular solutions are needed to transmit video signals.

The United States patent document No. US2006019673A1, another application in the state of the art, discloses a system which realizes an automatic channel allocation for mesh networks. In this application, the frequencies used in the channels are switched as a consequence of assessing the channel information received from the access points in the network.

The United States patent document no. US2008102845, an application in the state of the art, discloses a method for channel selection in wireless networks. But in this invention, carrying out real-time measurements during transmission of data such as voice or video is not mentioned. In addition in this invention, the fact that the data transfer rate is not interrupted during channel switch is emphasized rather than that it is kept high.

### SUMMARY OF THE INVENTION

The objective of the present invention is to realize a wireless mesh network and method of frequency optimization which enhances quality of data transmission by means of selecting the most appropriate channel automatically.

Another objective of the invention is to realize a wireless mesh network and a method of frequency optimization which operate in the IEEE 802.11n standards and wherein the channel switch is realized in accordance with the IEEE 802.11h standard.

A further objective of the invention is to realize a wireless mesh network and method of frequency optimization wherein no failure is experienced in channel selection and switch.

### DETAILED DESCRIPTION OF THE INVENTION

Wireless mesh network and method of frequency optimization realized to fulfill the objective of the present invention are illustrated in the accompanying figures, in which:

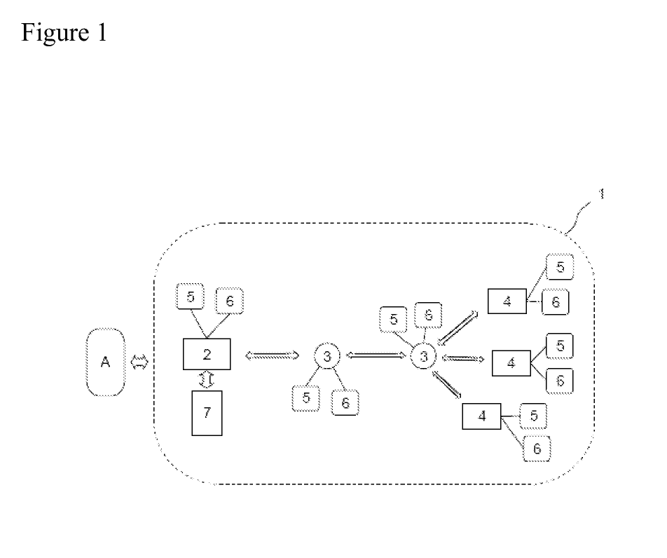

FIG. 1 is the schematic view of the inventive wireless mesh network.

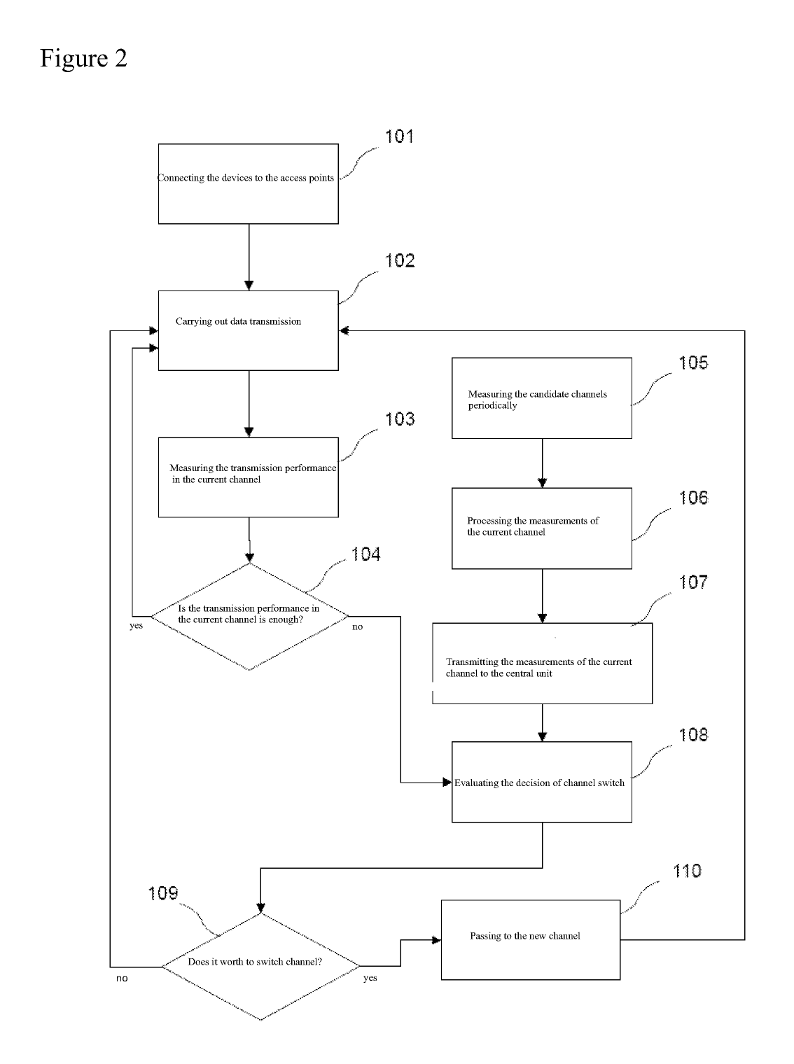

FIG. 2 is the flow chart of the inventive method of frequency optimization.

The parts given in the figures are individually numbered where the numbers refer to the following:
1. Wireless Mesh Network
2. Router
3. Access Point
4. Client Device
5. Module
6. Unit of Measurement
7. Central Unit

The inventive wireless mesh network (1) preferably comprises at least one router (2) over which the connection established with the other networks (A) is routed, at least one access point (3) which acts as a data transmission point in the network, at least one client device (4) which uses the network resources over access points and a central unit (7) which is in communication with the other devices in the wireless mesh network (1). The wireless mesh network (1) operates with the IEEE 802.11h standards compatibly.

The wireless mesh network (1) also comprises (FIG. 1)
at least one measuring/evaluation module (5) which carries out periodic measurements relative to alternative (candidate) channels upon the wireless mesh network (1) begins to operate, scores the measurements that it has carried out by evaluating and sends the results to the central unit (7); which is in communication with the device (2, 3 or 4) that it operates with, to be at least one for at least one of the router (2), the access point (3) and the client devices (4),
at least one unit of measurement (6) which periodically measures and evaluates the performance of data transmission in the current channel upon the wireless mesh network (1) begins to operate and sends the results to the central unit (7), which is in communication with the device (2, 3 or 4) that it operates with, to be at least one for at least one of the router (2), the access point (3) and the client devices (4) and
a central unit (7) which gets the results of channel evaluation sent by the module (5) and the unit of measurement (6), investigates whether there is a channel on which the wireless mesh network (1) will operate better according to these results and in case that it determines that there is such a channel, enables to switch the used channel in the devices (2, 3 or 4) synchronously by sending a channel switch command to the other devices (2, 3 or 4) in the wireless mesh network (1).

The measuring/evaluation modules (5) operate with the router (2), the access point (3) and the client device (4) to which it is connected. The module (5) enables the device (2, 3 or 4), that it is connected to, to operate in a different frequency (alternative/candidate channel) for short times (for example, 100 ms) at certain intervals by means of periodically sending commands to the device (2, 3 or 4) that it is connected to. During the short-term operation of the device (2, 3 or 4), to which the module is connected, in this frequency; the measurements relative to quality of transmission in the candidate channel corresponding to the said frequency are taken from the device (2, 3 or 4) by the module (5). Each module (5) makes the measurements taken free from noise by filtering them at first and subjects the measurements filtered to a certain scoring. Thus each module (5) composes a score value indicating availability of the channel for each different candidate channels. The scores composed for the candidate channels are sent to the central unit (7) periodically.

The units of measurement (6) measures the performance of data transmission in the current channel at regular intervals and controls whether the performance of the current channel is enough or not. Each unit of measurement (6) subjects the measurements to scoring in a similar way with the modules (5). Thus, the unit of measurement (6) composes a score value which represents the transmission performance of the current channel. The scores composed for the current channel is sent to the central unit (7) periodically. The units of measurement (6) are preferably radio chips integrated with the router (2), the access points (3) and the client devices (4).

The central unit (7) is a unit wherein the scores received from the measuring/evaluation modules (5) and the performance measurements of the current channel received from the units of measurement (6) are collected. The central unit (7) is in communication with the other devices (2, 3 or 4) in the wireless mesh network (1) besides the modules (5) and the units of measurement (6). The scores belonging to the candidate channels are examined by the central unit (7) by means of comparing and the channel which will give the best performance of data transmission between the candidate channels is determined. The central unit (7) also ascertains whether there is a channel on which the wireless mesh network (1) will operate better by comparing the performance measurement of the data transmission in the current channel with the performance measurement of the candidate channel having the best score. The central unit (7) bases on criteria such as number of access point using the channel, CCA assessment indicating the occupancy ratio of the channel and previous scores during this comparison. In the event that a channel wherein the wireless mesh network (1) will operate better is determined, the central unit (7) sends a channel switch command to the other units (2, 3, 4) in the network (1). By means of the fact that the channel is switched synchronously in the entire network (1), the data transfer is not subjected to interruption and the continuity in the data flow is not affected negatively. The channel switch is realized in accordance with the IEEE 802.11h standardization.

In a preferred embodiment of the present invention the wireless mesh network (1) comprises a router (2), a one module (5) and unit of measurement (6) integrated with the said devices (2, 3 or 4) for each access point (3) and each client device (4). In addition, the central unit (7) is integrated with the router (2). In this embodiment; each module (5) and unit of measurement (6) enables the device (2, 3 or 4), that it is in communication with, to be operated in the candidate frequencies as short-term at periodical intervals. In this way; measurements are taken by means of the modules (5) and units of measurement (6), regarding the candidate channels and current channel from each different device (2, 3 or 4) present in the various points of the wireless mesh network (1) and all results are transmitted to the central unit (7).

In an alternative embodiment of the present invention the inventive wireless mesh network (1) comprises at least one router (2) over which the connection established with the other networks (A) is routed, at least one access point (3) which acts as a data transmission point in the network and a central unit (7) which is in communication with the other devices in the wireless mesh network (1). In this embodiment, there are at least one measuring/evaluation module (5) and at least one unit of measurement (6) in the wireless mesh network (1) which are in communication with the device (2 or 3) that they operate together, to be at least one for at least one of the router (2) and the access points (3).

In another embodiment of the present invention the inventive wireless mesh network (1) comprises at least one access point (3) which acts as a data transmission point in the network, at least one client device (4) which uses the network resources over access points and a central unit (7) which is in communication with the other devices in the wireless mesh network (1). In this embodiment, there are at least one measuring/evaluation module (5) and at least one unit of measurement (6) in the wireless mesh network (1) which are in communication with the device (3 or 4) that they operate together, to be at least one for at least one of the access points (3) and the client devices (4).

In an embodiment of the present invention; transmission of the channel measurement results (channel scores) in the modules (5) and performance measurements of the current channel carried out by the units of measurement (6), to the central unit (7) are realized periodically. Accordingly, the central unit (7) evaluates the measurements of the current channel and the scores of the candidate channel which are received periodically and decides in the matter of channel switch.

The method of frequency optimization which is used in the wireless mesh network (1) and which enables to select the most appropriate channel by monitoring the frequencies of the current and candidate channels wherein the data transmission within the network is carried out, comprises the steps of (FIG. 2):
connecting the client devices (4) to the access points (3) (101),
carrying out the data transmission (102),
measuring the transmission performance in the current channel (103),
deciding whether the transmission performance in the current channel is enough (104),
if the transmission performance is enough continuing to carry out the data transmission from the current channel (102),
measuring the candidate channels periodically (105),
processing the measurements of the current channel (106),
transmitting the measurements of the current channel to the central unit (7) (107),
if the transmission performance is not enough (108) evaluating the decision of channel switch,
deciding whether it worths to switch channel (109),
if it is decided that it does not worth to switch channel carrying out the data transmission from the current channel (102),
if it is decided that it worths to switch channel passing to a new channel (110) and carrying out the data transmission from the new channel (102).

When the client devices (4) located in the wireless mesh network (1) wherein the frequency optimization will be made, is connected to the access points (3) the wireless mesh network (1) begins to operate. Then transmission of the data such as video, image is started in the wireless mesh network (1) (102). The quality of data transmission is monitored continuously by the processes in the other steps of the method and the network is enabled to continue operating without any failure in the real-time data transmission by means of changing the communication channel, which is used when it is deemed necessary, in the entire wireless mesh network (1) automatically. For that purpose, the transmission performance in the wireless mesh network (1) is measured continuously by the units of measurement (6) (103) and transferred to the central unit (7) by scoring. The units of measurement (6) decide whether the transmission performance is enough or not according to the measurements they have carried out (104). If they decide that the transmission performance is enough the data transmission continues on the same channel without making any change on the wireless mesh network (1) (102). In case that the transmission performance is determined to be not enough, it is proceeded to the step of evaluating the decision of channel switch (108).

According to the inventive method, in case that the data transmission is determined to be not enough, the candidate channels having different frequencies than the current channel are monitored periodically for a possible channel switch.

On the other hand, upon the wireless mesh network (1) begins to operate each module (5) enables the device (2, 3 or 4), that it is connected to, to operate in the candidate channels for short time at periodical intervals. During this short-term operation, the operation performance in the said candidate channel is measured by the module (5) (105). Then the data obtained by measuring the candidate channels (105) are processed by the module (5) (106) in order to be brought in a format easily comparable with each other. The process of measuring the candidate channels (105) comprises to make the channel measurements free from noise by filtering them and give a certain score to each candidate channel according to the transmission performance in that channel.

The channel measurements calculated by composing a certain performance score for each channel via the modules (5) are periodically transferred to the central unit (7) wherein these measurements will be evaluated all together (107).

The central unit (7) evaluates the decision of channel switch (108) and decides whether it will worth to switch the best candidate channel (109) determined in the wireless mesh network (1), by means of using the data that it has received from the units of measurement (6) and the measuring/evaluation modules (5) regarding the performance of the current channel. In the step of evaluating the decision of channel switch (108) the central unit (7) determines the best candidate channel by means of comparing the score of the candidate channels coming from the modules (5). In the next step (109), the performances (scores) determined in the best candidate channel and the current channel are compared. In consequence of the comparison it is decided whether it will worth to switch channel (109) by checking if there is an important difference between the current channel and the candidate channel in favor of the candidate channel, or not. If the difference between score of the current channel and score of the candidate channel is over a certain threshold value, it is understood that proceeding to the candidate channel makes sense. During this comparison (109), criteria such as number of access point used at that moment and average density of the channels (CCA) are taken into consideration. In case that a decision is taken in the way that the difference between the current channel and the best candidate channel worths to switch channel, the central unit (7) enables the devices (2, 3 or 4) to pass to the new channel (the best candidate channel) synchronously (110) by sending command to the other devices (2, 3 or 4) in the wireless mesh network (1). In this case the inventive method continues with carrying out the data transmission within the wireless mesh network (1) from the new channel (102). Whereas in the event that the difference of score between the current channel and the best candidate channel is not high enough and therefore a decision is taken in the way that it does not worth to switch channel, the data transmission continues over the current channel (102) without making any change in the wireless mesh network.

By means of the inventive wireless mesh network (1) and the method of frequency optimization operating according to the IEEE 802.11n standards, the quality of data transmission is monitored continuously and it is ensured to use the channel having the best possible transmission performance by making the automatic channel selection among the candidate channels measurements of which have been carried out periodically. In addition by means of the channel switch realized according to the IEEE 802.11h standard and synchronously, especially the transmission of data (for example real-time video) which are real-time and require high quality of service can be carried out in high quality and without being affected by the process of channel switch.

1. A wireless mesh network comprising at least one access point which acts as a data transmission point in the network, at least one client device which uses the network resources over the access points and a central unit which is in communication with the other devices in the wireless mesh network characterized by
at least one measuring/evaluation module which carries out periodic measurements relative to alternative (candidate) channels upon the wireless mesh network begins to operate, scores the measurements that it has carried out by evaluating and sends the results to the central unit; which is in communication with the device that it operates with, to be at least one for at least one of the access point and the client devices,
at least one unit of measurement which periodically measures and evaluates the performance of data transmission in the current channel upon the wireless mesh network begins to operate and sends the results to the central unit, which is in communication with the device that it operates with, to be at least one for at least one of the access point and the client devices and
a central unit which gets the results of channel evaluation sent by the module and the unit of measurement, determines the best candidate channel by comparing the channel scores received from modules and in case that it determines that the performance of the candidate channel is better by comparing the performances in the best candidate channel determined and the current channel, enables the devices to pass to the best candidate channel synchronously by sending a channel switch command to the other devices in the wireless mesh network.

2. A wireless mesh network comprising at least one router over which the connection established with the other networks is routed, at least one access point which acts as a data transmission point in the network and a central unit which is in communication with the other devices in the wireless mesh network (1) characterized by
at least one measuring/evaluation module which carries out periodic measurements relative to alternative (candidate) channels upon the wireless mesh network begins to operate, scores the measurements that it has carried out by evaluating and sends the results to the central unit; which is in communication with the device that it operates with, to be at least one for at least one of the router and the access points,
at least one unit of measurement which periodically measures and evaluates the performance of data transmission in the current channel upon the wireless mesh network begins to operate and sends the results to the central unit, which is in communication with the device that it operates with, to be at least one for at least one of the router and the access points and
a central unit which gets the results of channel evaluation sent by the module and the unit of measurement, determines the best candidate channel by comparing the channel scores received from modules and in case that it determines that the performance of the candidate channel is better by comparing the performances in the best candidate channel determined and the current channel, enables the devices to pass to the best candidate channel synchronously by sending a channel switch command to the other devices in the wireless mesh network.

3. A wireless mesh network comprising at least one router over which the connection established with the other networks is routed, at least one access point which acts as a data transmission point in the network, at least one client device which uses the network resources over access points and a central unit which is in communication with the other devices in the wireless mesh network characterized by
at least one measuring/evaluation module which carries out periodic measurements relative to alternative (candidate) channels upon the wireless mesh network begins to operate, scores the measurements that it has carried out by evaluating and sends the results to the central unit; which is in communication with the device that it operates with, to be at least one for at least one of the router, the access point and the client devices,
at least one unit of measurement which periodically measures and evaluates the performance of data transmission in the current channel upon the wireless mesh network begins to operate and sends the results to the central unit, which is in communication with the device that it operates with, to be at least one for at least one of the router, the access point and the access points and
a central unit which gets the results of channel evaluation sent by the module) and the unit of measurement, determines the best candidate channel by comparing the channel scores received from modules and in case that it determines that the performance of the candidate channel is better by comparing the performances in the best candidate channel determined and the current channel, enables the devices to pass to the best candidate channel synchronously by sending a channel switch command to the other devices in the wireless mesh network.

4. A wireless mesh network according to claim 2, characterized by a module which makes the measurements that it has taken free from noise by filtering them and composes a score value indicating availability of the channel for each different candidate channels by using the filtered measurements.

5. A wireless mesh network according to claim 2, characterized by a module which enables the device, that it is connected to, to operate in a different frequency (candidate channel) for short times at certain intervals by means of periodically sending commands to it which takes the measurements relative to quality of transmission in the candidate channel corresponding to the said frequency, during the short-term operation of the device in this frequency.

6. A wireless mesh network according to claim 2, characterized by a module which periodically sends the scores that it has composed for the candidate channels to the central unit.

7. A wireless mesh network according to claim 2, characterized by a module which is one for the router, each access point and each client device and which is integrated with the said device.

8. A wireless mesh network according to claim 2, characterized by a unit of measurement which measures the performance of data transmission in the current channel regularly, controls whether the performance of the current channel is enough or not, periodically sends the results that it has obtained regarding to the performance of the current channel to the central unit by scoring them.

9. A wireless mesh network according to claim 2, characterized by a unit of measurement which is one for the router, each access point and each client device and which is integrated with the said device.

10. A wireless mesh network according to claim 2, characterized by a unit of measurement which is a radio chip.

11. A wireless mesh network according to claim 2, characterized by a central unit which is integrated with the router.

12. A method of frequency optimization which enables to select the most appropriate channel for the wireless mesh network by monitoring the frequencies of the current and candidate channels wherein the data transmission within the network is carried out, according to claim 2, characterized by the steps of
connecting the client devices to the access points,
carrying out data transmission,
measuring the transmission performance in the current channel,
deciding whether the transmission performance in the current channel is enough,
if the transmission performance is enough continuing to carry out data transmission from the current channel,
measuring the candidate channels periodically,
processing the measurements of the current channel,
transmitting the measurements of the current channel to the central unit,
if the transmission performance is not enough evaluating the decision of channel switch,
deciding whether it worths to switch channel,
if it is decided that it does not worth to switch channel carrying out data transmission from the current channel,
if it is decided that it worths to switch channel passing to a new channel and carrying out data transmission from the new channel.
